(19) United States
(12) Patent Application Publication
(10) Pub. No.: US 2016/0370660 A1
(43) Pub. Date: Dec. 22, 2016

(54) PIXEL STRUCTURE AND LIQUID CRYSTAL DISPLAY PANEL

(71) Applicant: SHENZHEN CHINA STAR OPTOELECTRONICS TECHNOLOGY CO. LTD., Guangdong (CN)

(72) Inventor: Feng ZHAO, Shenzhen, Guangdong (CN)

(73) Assignee: Shenzhen China Star Optoelectronics Technology Co. Ltd., Shenzhen, Guangdong (CN)

(21) Appl. No.: 14/433,623

(22) PCT Filed: Jan. 5, 2015
(86) PCT No.: PCT/CN2015/070099

§ 371 Date: Apr. 3, 2015

(30) Foreign Application Priority Data
Dec. 29, 2014 (CN) 201410843004.6

(51) Int. Cl. G02F 1/1343; G02F 1/137; G02F 1/1333

(52) U.S. Cl. CPC G02F 1/134309; G02F 1/133345; G02F 1/13439; G02F 1/137; G02F 2201/123; G02F 2001/134345; G02F 2201/121

(57) ABSTRACT

A pixel structure is provided. The pixel structure includes an insulating layer and a pixel electrode layer disposed overlying the insulating layer. The insulating layer includes a patterned first insulating region and a non-patterned second insulating region. The pixel electrode layer includes a non-patterned first pixel electrode region disposed overlying the first insulating region and a patterned second pixel electrode region disposed overlying the second insulating region. The invention further provides a liquid crystal display panel using the above pixel structure. By using the pixel structure of the invention, both the uniform and stable liquid crystal alignment and the relatively high optical transmittance can be obtained.

### TECHNICAL FIELD

The invention relates to the field of liquid crystal display technology, and particularly to a pixel structure and a liquid crystal display panel.

### DESCRIPTION OF RELATED ART

The Liquid crystal display device has held the dominant position of flat panel display devices and achieves the display of different images mainly by controlling liquid crystal molecules to be deflected in an applied electric field. The liquid crystal molecules are changed in deflection direction according to a change of the electric field, and the changed electric field is generated by controlling voltages applied on a common electrode and a pixel electrode. Since in the display technology, the presentation of image is achieved generally by controlling each pixel on the screen, and therefore in the liquid crystal display panel, it is needed to perform a voltage control to electrodes of each pixel so as to realize the control of movement direction of liquid crystal molecules corresponding to the pixel.

The electrode arrangement is an important part for forming a pixel structure of the pixel, and different pixel structures would have different control effect to the liquid crystal molecules.

For the conventional liquid crystal pixel structure, an electric field generated between the electrodes would appear a weak effective electric field, so that the liquid crystal molecules at this situation cannot be effectively rotated, the light cannot pass therethrough, resulting in inadequate optical transmittance of the liquid crystal pixel structure. In addition, the electric field between the electrodes also would appear a weak lateral electric field, which leads to the lack of ability of controlling the movement direction of liquid crystal molecules, a uniform and stable liquid crystal alignment cannot be formed and even a disclination line would be easily occurred.

### SUMMARY

Accordingly, the invention provides a pixel structure, so as to solve the problems of low optical transmittance or non-uniform and unstable liquid crystal alignment of the liquid crystal pixel structure in the prior art.

In order to solve the above technical problem, the invention provides a pixel structure. The pixel structure includes a pixel electrode layer and an insulating layer. The pixel electrode layer is disposed overlying the insulating layer. The insulating layer includes a patterned first insulating region and a non-patterned second insulating region. The pixel electrode layer includes a non-patterned first pixel electrode region disposed overlying the first insulating region and a patterned second pixel electrode region disposed overlying the second insulating region. The second insulating region is disposed surrounding the first insulating region, and the second pixel electrode region is disposed surrounding the first pixel electrode region. The patterned first insulating region is a grooved structure, and the patterned second pixel electrode region is a striped structure.

In an embodiment, a boundary of the first insulating region is rectangular, prismatic, elliptical or irregular geometry.

In order to solve the above technical problem, the invention further provides a pixel structure. The pixel structure includes a pixel electrode layer and an insulating layer. The pixel electrode layer is disposed overlying the insulating layer. The insulating layer includes a patterned first insulating region and a non-patterned second insulating region. The pixel electrode layer includes a non-patterned first pixel electrode region disposed overlying the first insulating region and a patterned second pixel electrode region disposed overlying the second insulating region.

In an embodiment, the second insulating region is disposed surrounding the first insulating region, and the second pixel electrode region is disposed surrounding the first pixel electrode region.

In an embodiment, a boundary of the first insulating region is rectangular, prismatic, elliptical or irregular geometry.

In an alternative embodiment, the first insulating region is disposed surrounding the second insulating region, and the first pixel electrode region is disposed surrounding the second pixel electrode region.

In an embodiment, a boundary of the second insulating region is rectangular, prismatic, elliptical or irregular geometry.

In an embodiment, the patterned first insulating region is a grooved structure, and the patterned second pixel electrode region is a striped structure.

In an embodiment, the grooved structure includes grooves and protrusions, all the grooves have a same width, and all the protrusions have a same width.

In an embodiment, depths of the grooves each are less than a thickness of the insulating layer.

In an embodiment, the pixel electrode layer uses ITO electrodes.

In order to solve the above technical problem, the invention provides a liquid crystal display panel. The liquid crystal display panel includes a pixel structure. The pixel structure includes a pixel electrode layer and an insulating layer. The pixel electrode layer is disposed overlying the insulating layer. The insulating layer includes a patterned first insulating region and a non-patterned second insulating region. The pixel electrode layer includes a non-patterned first pixel electrode region disposed overlying the first insulating region and a patterned second pixel electrode region disposed overlying the second insulating region.

In an embodiment, the second insulating region is disposed surrounding the first insulating region, and the second pixel electrode region is disposed surrounding the first pixel electrode region.

In an embodiment, a boundary of the first insulating region is rectangular, prismatic, elliptical or irregular geometry.

In an alternative embodiment, the first insulating region is disposed surrounding the second insulating region, and the first pixel electrode region is disposed surrounding the second pixel electrode region.

In an embodiment, a boundary of the second insulating region is rectangular, prismatic, elliptical or irregular geometry.

In an embodiment, the patterned first insulating region is a grooved structure, and the patterned second pixel electrode region is a striped structure.

In an embodiment, the grooved structure includes grooves and protrusions, all the grooves have a same width, and all the protrusions have a same width.

In an embodiment, depths of the grooves each are less than a thickness of the insulating layer.

In an embodiment, the pixel electrode layer uses ITO electrodes.

The efficacy can be achieved by the invention is that: different from the prior art, the pixel structure of the invention includes a pixel electrode layer and an insulating layer, the pixel electrode layer is dispose overlying the insulating layer, the insulating layer includes a patterned first insulating region and a non-patterned second insulating region, and correspondingly the pixel electrode layer disposed overlying the insulating layer includes a non-patterned first pixel electrode region and a patterned second pixel electrode region. The electrode in the first pixel electrode region is arranged along the pattern of the first insulting region, and the first pixel electrode region is an unetched and non-patterned electrode layer, that is, the electrode in the first pixel electrode region has no electrode gap, so that liquid crystal molecules corresponding to the first pixel electrode region can obtain a relatively strong effective electric field, and correspondingly a relatively high optical transmittance can be obtained. In another aspect, electrodes in the second pixel electrode region are arranged on the non-patterned second insulating region, the electrodes in the patterned second pixel electrode region have a electrode gap and thus can generate a relatively strong lateral electric field to control the alignment of liquid crystal molecules and thereby form a uniform and stable liquid crystal alignment. The pixel structure of the invention uses the two types of electrode regions in combination, so that the liquid crystal region of the whole pixel structure can achieve both the relatively high optical transmittance and the uniform and stable liquid crystal alignment.

### BRIEF DESCRIPTION OF THE DRAWINGS

In order to more clearly illustrate the technical solutions of various embodiments of the present invention, drawings will be used in the description of embodiments will be given a brief description below. Apparently, the drawings in the following description only are some embodiments of the invention, the ordinary skill in the art can obtain other drawings according to these illustrated drawings without creative effort. In the drawings:

FIG. 1 is a structural schematic view of an embodiment of a pixel structure of the invention;

FIG. 2 is two cross-sectional views taken along A-A direction and B-B direction in FIG. 1;

FIG. 3 is a schematic view of a pixel structure in which a boundary of the inner insulating region is prismatic;

FIG. 4 is a schematic view of a pixel structure in which a boundary of the inner insulating region is elliptical;

FIG. 5 shows a pattern of a first insulating region or a second pixel electrode region in the pixel structure of the invention;

FIG. 6 shows another pattern of a first insulating region or a second pixel electrode region in the pixel structure of the invention;

FIG. 7 is a schematic view of optical transmittances at different voltages for the pixel structure as shown in FIG. 1 and a traditional pixel structure;

FIG. 8 is optical microscopic images of the pixel structure as shown in FIG. 1 and traditional pixel structures;

FIG. 9 is a structural schematic view of an embodiment of a liquid crystal display panel of the invention; and

FIG. 10 is a schematic view of a pixel structure in the liquid crystal display panel as shown in FIG. 9.

### DETAILED DESCRIPTION OF EMBODIMENTS

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

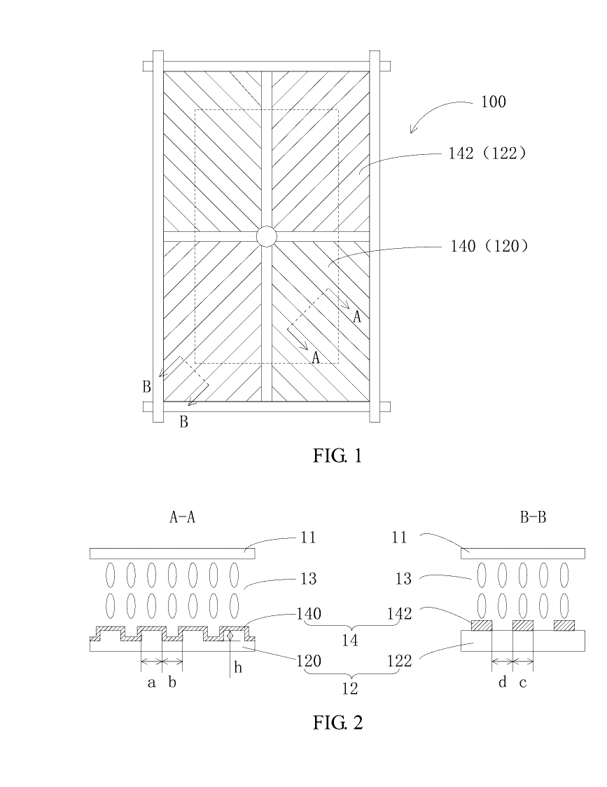

Referring to FIG. 1 and FIG. 2, FIG. 1 is a structural schematic view of an embodiment of a pixel structure of the invention, and FIG. 2 is two cross-sectional views taken along A-A direction and B-B direction in FIG. 1. In particular, the pixel structure 100 provided by this embodiment includes an insulating layer 12 and a pixel electrode layer 14. The insulating layer 12 includes a patterned first insulating region 120 and a non-patterned second insulating region 122. The pixel electrode layer 14 includes a non-patterned first pixel electrode region 140 and a patterned second pixel electrode region 142. The first pixel electrode region 140 is disposed overlying the first insulating region 120, and the second pixel electrode region 142 is disposed overlying the second insulating region 122.

The pixel structure 100 in this embodiment further includes a common electrode layer 11 and a liquid crystal layer 13, and the liquid crystal layer 13 is arranged between the common electrode layer 11 and the pixel electrode layer 14. A liquid crystal display panel corresponding to the pixel structure 100 is VA (vertical alignment) mode, and it should be understood that the pixel structure 100 also may be applied to other mode display panel. The liquid crystal layer 13 in the pixel structure 100 is vertically aligned, and the liquid crystal display panel is normally-black mode. When the common electrode layer 11 and the pixel electrode layer 14 have a potential difference formed therebetween to generate an electric field, liquid crystal molecules are rotated under the effect of the electric field, and light can pass through the liquid crystal layer 13. Since different potential differences would cause different rotation angles of liquid crystal molecules, and the liquid crystal layer 13 correspondingly would exhibit different optical transmittances, and therefore a grayscale of each pixel can be controlled by voltage, and a grayscale change of RGB sub-pixels in each pixel can achieve the change of color of the liquid crystal display.

In this embodiment, the first insulating region 120 of the insulating layer 12 is patterned by a lithography process or an embossing process, and then an electrode is directly formed overlying the first insulating region 120 by a process such as chemical deposition, coating or tabletting to form the first pixel electrode region 140 of the pixel electrode layer 14.

For the second pixel electrode region 142 of the pixel electrode layer 14, the electrode layer may be patterned by a lithography process. Concretely speaking, a layer of electrode firstly is formed overlying the second insulting area 122 by a process such as chemical deposition, coating or tabletting, and the layer of electrode then is etched by laser to form a certain pattern. As a result, the formation of the patterned second pixel electrode region 142 overlying the non-patterned second insulating region 122 is realized.

Since the electrode in the first pixel electrode region 140 is continuously arranged along the pattern of the first insulating region 120, the first pixel electrode region 140 has no hollowing area, the continuously arranged electrode would generate an effective electric field perpendicular to the electrode layer, and meanwhile a lateral electric field parallel to the electrode layer correspondingly is relatively weak. The relatively strong effective electric field would make the liquid crystal layer corresponding to the first pixel electrode region 140 have a relatively high optical transmittance, the weak lateral electric field would make corresponding liquid crystal molecules be susceptible to the influence of fringe field effect and thereby a movement deviated from the normal direction occurs on the liquid crystal molecules so that the arrangement directions produce a discontinuous change and a disclination line would be easily occurred. The so-called fringe field effect is that because of mutual influence of different control voltage between neighboring two pixels, a parallel electric field is generated between neighboring electrodes of neighboring pixels, and the movement of liquid crystal molecules in the pixels are affected.

The second pixel electrode region 142 has the patterned electrodes, the effective electric field at the location of hollowing patterns is relatively weak, and therefore the optical transmittance correspondingly is relatively low. Due to the presence of hollowing patterns, the liquid crystal molecules at the boundaries would be twisted, which also leads to the low optical transmittance; and meanwhile a relatively strong lateral electric field would be easily generated at the boundaries, which is beneficial to the movement of the liquid crystal molecules and thereby to form a uniform and stable liquid crystal alignment. The fringe field effect has a less influence to the movement of the liquid crystal molecules than the lateral electric field, and therefore the optical transmittance of the liquid crystal layer corresponding to the second pixel electrode region 142 is relatively low, corresponding liquid crystal molecules would not be easily deviated from the normal direction and a disclination line would not be easily occurred.

In this embodiment, since the pixel structure 100 has both the first pixel electrode region 140 and the second pixel electrode region 142, and the electric fields formed by the two electrode regions with the common electrode layer 11 both can act on the liquid crystal molecules in the whole liquid crystal layer 13, so that the movement of the liquid crystal molecules would not easily be affected by the fringe field effect; and for the pixel structure 100 as a whole, good optical transmittance and uniform and stable liquid crystal alignment both can be achieved.

Based on the above principle, the positional relationship of the first insulating region 120 and the second insulating region 122 has a variety of implementations, for example, the first insulating region 120 may be disposed surrounding the second insulating region 122 and at this situation the boundary of the second insulating region 122 may be rectangular, prismatic, elliptical or irregular geometry; or, the second insulating region 122 is disposed surrounding the first insulating region 122 instead and at this situation the boundary of the first insulating region 120 may be rectangular, prismatic, elliptical or irregular geometry.

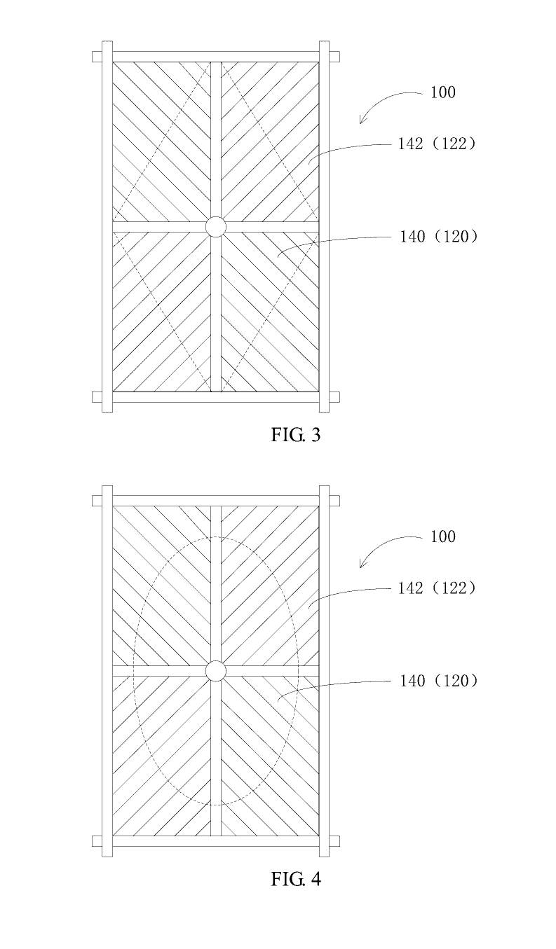

In order to facilitate the liquid crystal display panel to achieve good display effect, it is preferable to make the electric field in the pixel structure 100 be symmetrically distributed so as to generate centrosymmetric influence on the liquid crystal layer 13. The first insulating region 120 and the second insulating region 122 in the pixel structure 100 each are a centrosymmetric structure. Therefore, one insulating region generally is disposed surrounding the other one insulating region, and the boundary of the inner insulating region is a regular geometry such as rectangular, prismatic or elliptical. As shown in FIG. 3 and FIG. 4, FIG. 3 is a schematic view of a pixel structure in which the boundary of the inner insulating region is prismatic, and FIG. 4 is a schematic view of a pixel structure in which the boundary of the inner insulating region is elliptical.

When the second insulating region 122 and the patterned second pixel electrode region 142 as shown in FIG. 2 are used as the periphery of the pixel structure 100, the second pixel electrode region 142 can generate a relatively strong lateral electric field so that the peripheral liquid crystal molecules would encounter little influence from the fringe field effect and a disclination line would not be easily occurred. Moreover, the inner first pixel electrode region 140 of the pixel structure 100 can generate a relatively strong effective electric field, so that the inner optical transmittance is relatively high and the overall effect of the pixel structure 100 is good. If the increase of optical transmittance and the prevention of disclination line both are given equal considerations, an area ratio of the first insulating region 120 to the second insulating region 122 may be set as 1:1, and correspondingly an area ratio of the first pixel electrode region 140 to the second pixel electrode region 142 is set as 1:1. If by improving a light source system, it has been able to make people could not easily perceive the dark stripe any more, that is, the prevention of disclination line requires much more consideration, at this situation the area ratio of the first insulating region 120 to the second insulating region 122 can be set as 1:2, and correspondingly the area ratio of the first pixel electrode region 140 to the second pixel electrode region 142 is set as 1:2. Likewise, for the whole liquid crystal display panel, if the optical transmittance requires much more consideration, the area ratio of the first insulating region 120 to the second insulating region 122 may be set as 2:1, and correspondingly the area ratio of the first pixel electrode region 140 to the second pixel electrode region 142 is set as 2:1. It should be understood that, the above area ratios can be set as 1:3, 2:3, 3:5 and so on according to actual requirement.

When the patterned first insulating region 120 and the first pixel electrode region 140 are used as the periphery of the pixel structure 100, a lateral electric field generated by the first pixel electrode region 140 is relatively weak, so that the peripheral liquid crystal molecules would encounter a large influence from the fringe field effect; and a lateral electric field generated by the inner second pixel electrode region 142 is relatively strong, so that the central liquid crystal molecules would encounter little influence from the fringe field effect. If the area of the first pixel electrode region 140 is relatively small, the liquid crystal molecules encountering the influence of the fringe field effect correspondingly is less, and relatively it is not easily to form a disclination line. Therefore, the area ratio of the first insulating region to the second insulating region generally is selected as 1:1 or 1:2; of course, the above area ratio may be selected as 1:3, 2:3 or 3:5 and so on.

In this embodiment, the second insulating region 122 and the patterned second pixel electrode region 142 are used as the periphery of the pixel structure 100, the boundary of the inner first insulating region 120 is rectangular, and the area ratio of the first insulating region 120 to the second insulating region 122 is 1:1.

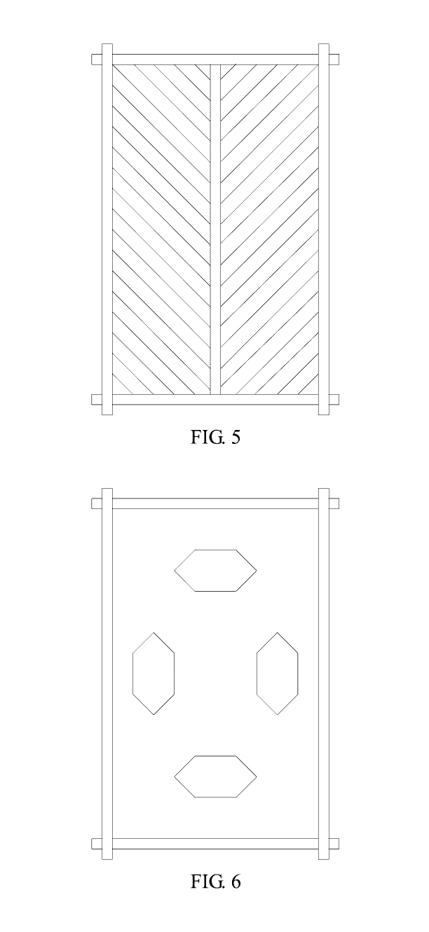

In order to achieve wide viewing angle effect of liquid crystal display panel, in this embodiment, a pattern of the first insulating region 120 and a pattern of the second pixel electrode region 142 both are a pattern using a same point as a center and radiating toward four directions. Of course, if other purpose is considered, other pattern can be used instead, for example the illustrations of FIG. 5 and FIG. 6, FIG. 5 is a pattern of the first insulating region or the second pixel electrode region in the pixel structure of the invention, and FIG. 6 is another pattern of the first insulating region or the second pixel electrode region in the pixel structure of the invention; that is, the patterns of the first insulating region and the second pixel electrode region each can be a symmetrical pattern radiating toward two directions (see FIG. 5), or a plurality of regularly arranged hexagonal patterns (see FIG. 6). In addition, based on the above description, the patterns of the first insulating region and the second pixel electrode region each also may be a pattern radiating toward three or much more directions, or a plurality of regularly or irregularly arranged triangular or square patterns, and so on.

In conjunction with the illustration of FIG. 2, concretely speaking, the patterned first insulating region 120 is a grooved structure and has alternately arranged grooves and protrusions. In order to facilitate the manufacturing process, widths of all the grooves generally are set as a, widths of all the protrusions are set as b, and a may be equal to or not equal to b. Moreover, in order to avoid the grooves to be hollowing structures that could not support the electrode in the first pixel electrode region 140, during forming the pattern of the first insulating region 120, it is needed to ensure that a depth h of each groove does not exceed the thickness of the insulating layer. The patterned second pixel electrode region 142 is a striped structure, and based on the consideration of manufacturing process, widths of all the striped electrodes are set as c, a gap width of each two neighboring striped electrodes is set as d, and c is equal to or not equal to b.

For the insulating layer 12, it generally is a glass substrate in actual application, a thickness thereof mainly is 0.7 mm or 0.5 mm, and 0.5 mm is selected in this embodiment. Therefore, the groove depth of the first insulating region 120 generally is set as 0.3 mm, if the manufacturing process can reach a high machining precision, the groove depth can be set as 0.4 mm, the corresponding electrode of the first pixel electrode region 140 overlying the grooves and protrusions can generate a relative large lateral electric field, which can avoid the disclination line to some extent. In order to ensure the consistency of the whole pixel structure 100, the electrodes in the first pixel electrode region 140 and the second pixel electrode region 142 are formed with a same thickness, the widths b of the protrusions and the widths c of the striped electrodes all are 7 micrometers (μm), the widths a of the grooves and the gap width d between each two striped structures all are 3 μm. Of course, the above widths may be different instead or other values.

In order to increase the light transmittance, the electrodes of the pixel electrode layer 14 and the common electrode layer 11 in this embodiment all employ ITO (indium tin oxide) electrodes, and of course, other electrode material such as a metal compound can be employed instead.

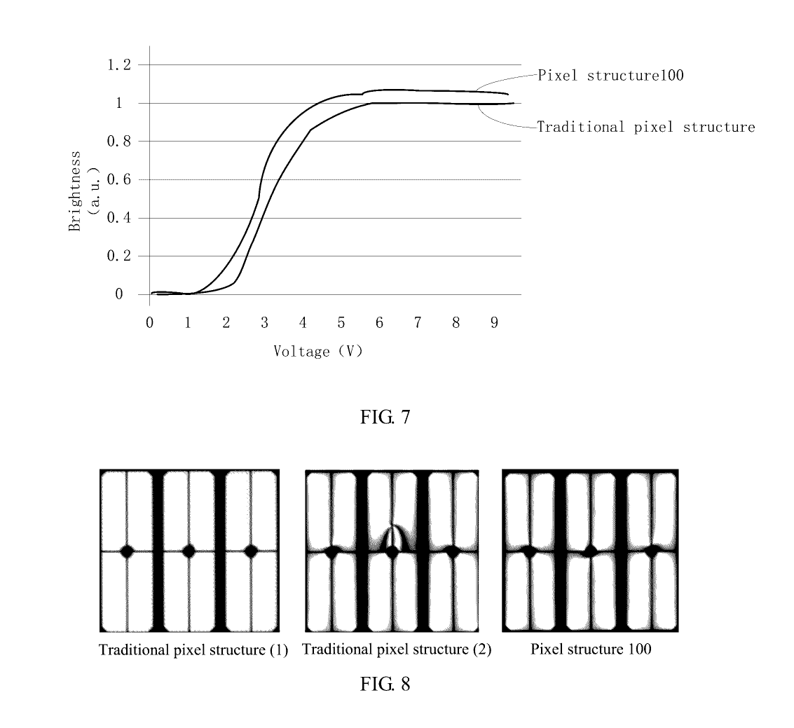

After performing experiments on the pixel structure 100 in this embodiment and a traditional pixel structure, optical microscopic images and a curve diagram of optical transmittances at different voltages are obtained. For details, please refer to FIG. 7 and FIG. 8, FIG. 7 is a schematic view of optical transmittances at different voltages for the pixel structure as shown in FIG. 1 and a traditional pixel structure, and FIG. 8 shows optical microscopic images of the pixel structure as shown in FIG. 1 and traditional pixel structures. In FIG. 7, the optical transmittance is represented by brightness, and it can be found that compared with the traditional pixel structure, the pixel structure 100 has a relatively higher optical transmittance. As seen from FIG. 8, the traditional pixel structures may appear easily perceptible dark stripes or disclination lines, while the pixel structure 100 has no easily perceptible dark stripe and can avoid the disclination line, i.e., both high optical transmittance and uniform and stable liquid crystal alignment are achieved.

Different from the prior art, the pixel structure in this embodiment includes a pixel electrode layer and an insulating layer, the insulating layer includes a patterned first insulating region and a non-patterned second insulating region, and correspondingly the pixel electrode layer disposed overlying the insulating layer includes a non-patterned first electrode region and a patterned second electrode region. The electrode in the first pixel electrode region is arranged along a pattern of the first insulating region and thus has no electrode gap, so that the liquid crystal molecules corresponding to the first pixel electrode region can obtain a relatively strong effective electric field and correspondingly a relatively high optical transmittance can be obtained. The electrodes in the second pixel electrode region are formed overlying the non-patterned second insulating region, and therefore the electrodes in the patterned second pixel electrode region have an electrode gap formed thereamong, a relatively strong lateral electric field can be generated to control the alignment of liquid crystal and thereby form uniform and stable liquid crystal alignment. The pixel structure of the invention uses the two types of electrodes in combination, so that the liquid crystal region of the whole pixel structure can have both relatively high optical transmittance and uniform and stable liquid crystal alignment.

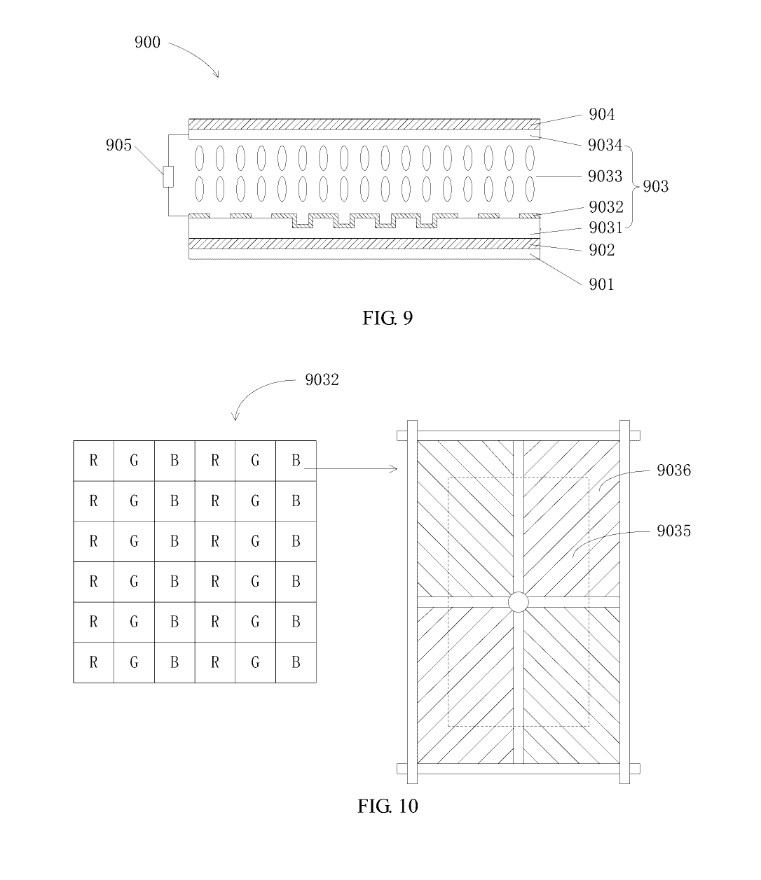

Referring to FIG. 9, a structural schematic view of an embodiment of a liquid crystal display panel of the invention is shown. The liquid crystal display panel 900 provided in this embodiment, from bottom to top, includes a light source 901, a lower polarizing plate 902, a pixel structure 903 and an upper polarizing plate 904 arranged in that order. The liquid crystal display panel 900 further includes a driving device 905 configured for supplying required drive control signals to the pixel structure 903.

Specifically, the pixel structure 903 includes an insulating layer 9031, a pixel electrode layer 9032, a liquid crystal layer 9033 and a common electrode layer 9034. Please refer to FIG. 10, a schematic view of the pixel structure in the liquid crystal display panel as shown in FIG. 9 is shown. Since the pixel electrode layer is arranged overlying the insulating layer, the pixel electrode layer 9032 is used as an example in FIG. 10 for illustration. In particular, three primary colors RGB sub-pixel structures are sequentially arranged, each sub-pixel structure has an inner first pixel electrode region 9035 and an outer second pixel electrode region 9036, the sub-pixel structure in FIG. 10 is similar to the pixel structure 100 in FIG. 1 and thus can achieve good optical transmittance and uniform and stable liquid crystal alignment, the concrete structure thereof can refer to the foregoing description associated with the pixel structure 100 in FIG. 1 and thus will not be repeated herein.

Different from the prior art, the pixel structure used in the liquid crystal display panel of this embodiment can achieve relatively high optical transmittance and uniform and stable liquid crystal alignment, so that the liquid crystal display panel in this embodiment can realize better display effect.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A pixel structure comprising a pixel electrode layer and an insulating layer, and the pixel electrode layer being disposed overlying the insulating layer; wherein
the insulating layer comprises a patterned first insulating region and a non-patterned second insulating region;
the pixel electrode layer comprises a non-patterned first pixel electrode region disposed overlying the first insulating region and a patterned second pixel electrode region disposed overlying the second insulating region;
the second insulating region is disposed surrounding the first insulating region, and the second pixel electrode region is disposed surrounding the first pixel electrode region;
the patterned first insulating region is a grooved structure, and the patterned second pixel electrode region is a striped structure.

2. The pixel structure as claimed in claim 1, wherein a boundary of the first insulating region is rectangular, prismatic, elliptical or irregular geometry.

3. A pixel structure comprising a pixel electrode layer and an insulating layer, and the pixel electrode layer being disposed overlying the insulating layer; wherein
the insulating layer comprises a patterned first insulating region and a non-patterned second insulating region;
the pixel electrode layer comprises a non-patterned first pixel electrode region disposed overlying the first insulating region and a patterned second pixel electrode region disposed overlying the second insulating region.

4. The pixel structure as claimed in claim 3, wherein the second insulating region is disposed surrounding the first insulating region, and the second pixel electrode region is disposed surrounding the first pixel electrode region.

5. The pixel structure as claimed in claim 4, wherein a boundary of the first insulating region is rectangular, prismatic, elliptical or irregular geometry.

6. The pixel structure as claimed in claim 3, wherein the first insulating region is disposed surrounding the second insulating region, and the first pixel electrode region is disposed surrounding the second pixel electrode region.

7. The pixel structure as claimed in claim 6, wherein a boundary of the second insulating region is rectangular, prismatic, elliptical or irregular geometry.

8. The pixel structure as claimed in claim 3, wherein the patterned first insulating region is a grooved structure, and the patterned second pixel electrode region is a striped structure.

9. The pixel structure as claimed in claim 8, wherein the grooved structure comprises grooves and protrusions, all the grooves have a same width, and all the protrusions have a same width.

10. The pixel structure as claimed in claim 9, wherein depths of the grooves each are less than a thickness of the insulating layer.

11. The pixel structure as claimed in claim 3, wherein the pixel electrode layer uses ITO electrodes.

12. A liquid crystal display panel comprising a pixel structure, the pixel structure comprising a pixel electrode layer and an insulating layer, and the pixel electrode layer being disposed overlying the insulating layer; wherein
the insulating layer comprises a patterned first insulating region and a non-patterned second insulating region;
the pixel electrode layer comprises a non-patterned first pixel electrode region disposed overlying the first insulating region and a patterned second pixel electrode region disposed overlying the second insulating region.

13. The liquid crystal display panel as claimed in claim 12, wherein the second insulating region is disposed surrounding the first insulating region, and the second pixel electrode region is disposed surrounding the first pixel electrode region.

14. The liquid crystal display panel as claimed in claim 13, wherein a boundary of the first insulating region is rectangular, prismatic, elliptical or irregular geometry.

15. The liquid crystal display panel as claimed in claim 12, wherein the first insulating region is disposed surrounding the second insulating region, and the first pixel electrode region is disposed surrounding the second pixel electrode region.

16. The liquid crystal display panel as claimed in claim 15, wherein a boundary of the second insulating region is rectangular, prismatic, elliptical or irregular geometry.

17. The liquid crystal display panel as claimed in claim 12, wherein the patterned first insulating region is a grooved structure, and the patterned second pixel electrode region is a striped structure.

18. The liquid crystal display panel as claimed in claim 17, wherein the grooved structure comprises grooves and protrusions, all the grooves have a same width, and all the protrusions have a same width.

19. The liquid crystal display panel as claimed in claim 18, wherein depths of the grooves each are less than a thickness of the insulating layer.

20. The liquid crystal display panel as claimed in claim 12, wherein the pixel electrode layer uses ITO electrodes.
